(19) United States
(12) Patent Application Publication
(10) Pub. No.: US 2004/0062701 A1
(43) Pub. Date: Apr. 1, 2004

(54) Method for preparing precipitated silica containing aluminium

(76) Inventors: Remi Valero, Lyon (FR); Yvonick Chevallier, Fontaines Saint Martin (FR)

Correspondence Address: BURNS DOANE SWECKER & MATHIS L L P, POST OFFICE BOX 1404, ALEXANDRIA, VA, 22313-1404, US

(21) Appl. No.: 10/451,909

(22) PCT Filed: Dec. 26, 2001
(86) PCT No.: PCT/FR01/04205

(30) Foreign Application Priority Data
Dec. 28, 2000 (FR) 00/17236

(51) Int. Cl. C01B 33/12

(52) U.S. Cl. 423/339; 423/327.1

(57) ABSTRACT

The invention concerns a method for preparing precipitated silica comprising reaction of a silicate with an acidifying agent whereby is obtained a precipitated silica suspension, then separating and drying said suspension. The invention is characterised in that said method comprises the following process: adding to the reaction medium at least a compound A of aluminium; then adding to the reaction medium an acidifying agent, said separation comprising filtration and disintegration of the cake derived from said filtration, said disintegration being preferably carried out in the presence of at least a compound B of aluminium. The thus prepared silica precipitates are particularly well adapted for use as reinforcing elastomer filler.

The present invention relates to a new process for the preparation of precipitated silica, more particularly to precipitated silicas which are in the form of powder, of substantially spherical beads or of granules, and to the application of the silicas thus obtained as a reinforcing filler for elastomers.

It is known that precipitated silica has been employed for a long time as a white reinforcing filler in elastomers.

However, like any reinforcing filler, it is appropriate that it should be capable of, on the one hand, being handled and above all, on the other hand, of being easily incorporated into the mixtures.

It is known in general that, to obtain the optimum reinforcing properties conferred by a filler, it is appropriate that the latter should be present in the elastomer matrix in a final form which is both as finely divided as possible and distributed as homogeneously as possible. However, such conditions can be achieved only insofar as, on the one hand, the filler has a very good ability to be incorporated into the matrix during mixing with the elastomer (incorporability of the filler) and to disintegrate or to deagglomerate into the form of a very fine powder (disintegration of the filler) and as, on the other hand, the powder resulting from the abovementioned disintegration process can itself, in its turn, be perfectly and homogeneously dispersed in the elastomer (dispersion of the powder).

Moreover, for reasons of mutual affinities, silica particles have an unfortunate tendency, in the elastomer matrix, to agglomerate with each other. These interactions have a detrimental consequence of limiting the reinforcing properties to a level that is substantially lower than that which it would be theoretically possible to expect if all the silica/elastomer interactions capable of being created during the mixing operation were actually obtained (this theoretical number of silica/elastomer interactions being, as is well known, directly proportional to the external surface of the silica employed). To increase the silica/elastomer interactions, it is possible to incorporate so-called coupling agents promoting these interactions. Thus, in this case, it is advantageous to prepare precipitated silica which exhibits good reactivity with these coupling agents.

Furthermore, in the raw state, such silica/silica interactions tend to increase the stiffness and the consistency of the mixtures, thus making them more difficult to process.

The problem arises of having available fillers which, while being capable of being relatively large in size, have a very good dispersibility in elastomers.

Processes which solve these problems have been proposed by the applicant. Thus, particular processes of preparation of precipitated silica during which in particular an aluminum compound (I) is added to the reaction mixture, after the stage of simultaneous addition of the acidifying agent and the alkali metal silicate; after this addition of aluminum compound, a filtration and a disintegration are carried out, the disintegration being performed in the presence of at least one aluminum compound (II), have thus been described in Patents EP 0762992 and EP 0762993. It is preferable, during the addition of the aluminum compound (I), to adjust the pH over time, starting with a decrease in pH, followed by a rise with the aid of a basic agent, generally sodium hydroxide, and finally a decrease in pH.

These processes produce precipitated silica having satisfactory properties, but they are not always easy to use. Among these properties, the silica obtained exhibits excellent reactivity toward coupling agents like especially bis[3-triethyoxysilylpropyl)tetrasulfane].

The aim of the present invention is to overcome the abovementioned disadvantages and to propose an alternative to the earlier processes.

More precisely, its aim is especially to propose a new preparation process which is simple and which allows in particular a high productivity of precipitated silica while providing very satisfactory properties for the silica obtained.

Its aim is therefore also to propose a simple new process for the preparation of precipitated silica which, advantageously, has a very good dispersibility (and disintegrability) and very satisfactory reinforcing properties, in particular which, when employed as a reinforcing filler for elastomers, imparts excellent rheological properties to the latter while providing them with good mechanical properties.

The present invention also relates to the use of said precipitated silicas as reinforcing fillers for elastomers.

In the description which follows, the BET specific surface is determined according to the Brunauer-Emmet-Teller method described in the Journal of the American Chemical Society, Vol. 60, page 309, February 1938 and corresponding to NFT standard 45007 (November 1987).

The CTAB specific surface is the outer surface determined according to NFT standard 45007 (November 1987) (5.12).

The DOP oil uptake is determined according to NFT standard 30-022 (March 1953) by using dioctyl phthalate.

The packing density (PD) is measured according to NFT standard 030100.

The pH is measured according to ISO standard 787/9 (pH of a suspension at a concentration of 5% in water).

Finally, it is specified that the given pore volumes are measured by mercury porosimetry, the pore diameters being calculated from the Washburn relationship with an angle of contact theta equal to 130° C. and a surface tension gamma equal to 484 dynes/cm (Micromeritics 9300 porosimeter).

The dispersibility and the disintegrability of the silica according to the invention can be quantified by means of a specific disintegrability test.

The disintegrability test is carried out according to the following procedure:

The cohesion of the agglomerates is assessed by a particle size measurement (using laser scattering), performed on a silica suspension previously disagglomerated by ultrasonic treatment; the disintegratability of the silica is thus measured (rupture of objects from 0.1 to a few tens of microns). The disintegration under ultrasound is performed with the aid of a Vibracell Bioblock (600 W) sonic transducer equipped with a probe 19 mm in diameter. The particle size measurement is performed by laser scattering on a Sympatec particle size analyser.

2 grams of silica are weighed into a specimen tube (height: 6 cm and diameter: 4 cm) and are made up to 50 grams by adding water treated with ion exchange media; an aqueous suspension containing 4% of silica is thus produced, which is homogenized for 2 minutes by magnetic stirring. The disintegration under ultrasound is next performed as follows: with the probe immersed to a depth of 4 cm, the power is adjusted so as to obtain a needle deflection on the power dial indicating 20%. The disintegration is performed for 420 seconds. The particle size measurement is then carried out after a known volume (expressed in ml) of the homogenized suspension has been introduced into the cell of the particle size analyser.

The value of the median diameter Ø₅₀ which is obtained is proportionally smaller the higher the disintegratability of the silica. The ratio (10× volume of suspension introduced (in ml))/optical density of the suspension detected by the particle size analyser (this optical density is of the order of 20) is also determined. This ratio is an indication of the proportion of fines, that is to say of the content of particles smaller than 0.1 μm, which are not detected by the particle size analyser. This ratio, called the ultrasonic disintegration factor (F_{D}) is proportionally higher the higher the disintegratability of the silica.

One of the subjects of the invention is therefore a process for the preparation of precipitated silica of the type including the reaction of a silicate with an acidifying agent, whereby a suspension of precipitated silica is obtained, followed by the separation and the drying of this suspension, in which the precipitation is carried out in the following manner:

(i) an initial base stock comprising a silicate and an electrolyte is formed, the silicate concentration (expressed as SiO₂) in said initial base stock being lower than 100 g/l and the electrolyte concentration in said initial base stock being lower than 17 g/l,

(ii) the acidifying agent is added to said base stock until a pH value of the reaction mixture of at least approximately 7 is obtained,

(iii) acidifying agent and a silicate are added simultaneously to the reaction mixture,

and in which a suspension which has a solids content of not more than 24% by weight is dried,

characterized in that said process includes the following operation:

(iv) at least one aluminum compound A is added to the reaction mixture after stage (iii), and then (v) an acidifying agent is added to the reaction mixture, said separation comprising a filtration and a disintegration of the cake originating from this filtration, said disintegration being preferably performed in the presence of at least one aluminum compound B.

Thus, no basic agent and silicate is added, more particularly during stages (iv) and (v) and between these two stages.

It has thus been found that the mere addition of aluminum at the stage (iv) followed by stage (v), which are described above, combined with a low concentration of silicate (expressed as SiO₂) and of electrolyte in the initial base stock and at an appropriate solids content of the suspension to be dried constitutes an important and sufficient condition for imparting their excellent properties to the products obtained, especially very satisfactory reinforcing properties.

It should be noted, in general, that the process concerned is a process for the synthesis of precipitated silica, that is to say that an acidifying agent is reacted with a silicate in very special conditions.

The choice of the acidifying agent and of the silicate is made in a manner which is well known per se.

It may be recalled that the acidifying agent generally employed is a strong inorganic acid such as sulfuric acid, nitric acid or hydrochloric acid, or an organic acid such as acetic acid, formic acid or carbonic acid.

The acidifying agent used in this process may be dilute or concentrated; its normality may be between 0.4 and 36 N, for example between 0.6 and 1.5 N.

In particular, in the case where the acidifying agent is sulfuric acid, its concentration may be between 40 and 180 g/l, for example between 60 and 130 g/l.

It is possible, furthermore, to employ as a silicate any common form of silicates such as metasilicates, disilicates and advantageously an alkali metal silicate, especially sodium or potassium silicate.

The silicate may exhibit a concentration, expressed as silica, of between 40 and 330 g/l, for example between 60 and 300 g/l, in particular between 60 and 250 g/l.

In general, sulfuric acid is employed as the acidifying agent, and sodium silicate as the silicate.

In the case where sodium silicate is employed, the latter generally exhibits an SiO₂/Na₂O weight ratio of between 2 and 4, for example between 3.0 and 3.7.

Insofar as the process of preparation of the invention is more particularly concerned, the precipitation is done in a specific manner according to the following stages.

First of all a base stock is formed which includes some silicate and an electrolyte (stage (i)). The quantity of silicate present in the initial base stock advantageously represents only a part of the total quantity of silicate introduced into the reaction.

According to one characteristic of the process of preparation according to the invention, the silicate concentration in the initial base stock is (higher than 0 g/l and) lower than 100 g of SiO₂ per liter. Preferably, this concentration is lower than 90 g/l, especially lower than 85 g/l. In some cases it may be lower than 80 g/l.

The term electrolyte is understood here in its normal accepted meaning, that is to say that it denotes any ionic or molecular substance which, when in solution, decomposes or dissociates to form ions or charged particles. An electrolyte which may be mentioned is a salt from the group of the alkali and alkaline-earth metal salts, especially the salt of the metal of the starting silicate and of the acidifying agent, for example sodium sulfate in the case of the reaction of a sodium silicate with sulfuric acid.

According to one characteristic of the process according to the invention the concentration of electrolyte in the initial base stock is (higher than 0 g/l and) lower than 17 g/l, preferably lower than 14 g/l.

The second stage consists in adding the acidifying agent to the base stock of composition described above (stage (ii)).

This addition, which entails a corresponding lowering in the pH of the reaction mixture, takes place until a pH value of at least approximately 7, generally between 7 and 8, is reached.

Once the desired pH value is reached, a simultaneous addition (stage (iii)) of acidifying agent and of silicate is then carried out.

This simultaneous addition is preferably carried out so that the pH value is continuously equal (to within ±0.1) to that reached at the end of stage (ii).

According to a preferred embodiment of the process according to the invention, after the simultaneous addition of stage (iii), the addition of silicate is stopped, but the addition of an acidifying agent continues during stage (iv) such that the pH value is constantly equal (to within ±0.1) to that reached at the end of stage (ii).

An acidifying agent is added to the reaction mixture according to stage (v) preferably such that a pH value of the reaction mixture of between 3 and 6.5, in particular 4 and 6, is obtained.

It may also be advantageous to perform the simultaneous addition of stage (iii) according to a duration which may vary from 5 to 60 minutes, in particular from 20 to 40 minutes.

The acidifying agent employed during stage (v) is generally identical to that employed during stages (ii) and (iii).

The maturing of the reaction mixture is advantageously performed after stage (v), for example for 2 to 60 minutes, in particular for 5 to 30 minutes.

The aluminum compound A employed in the process of preparation according to the invention is preferably an alkali metal, especially potassium, or very preferably sodium, aluminate.

The temperature of the reaction mixture is generally between 60 and 98° C.

According to an alternative form of the invention, the reaction is performed at a constant temperature of between 70 and 96° C.

According to another alternative form of the invention, the temperature at the end of the reaction is higher than the temperature at the beginning of the reaction: the temperature at the beginning of the reaction is thus maintained (especially during stage (ii)) preferably between 75 and 90° C., in particular between 80 and 85° C., and the temperature is then raised over a few minutes, preferably up to a value of between 85 and 98° C., in particular between 90 and 95° C., at which value it is maintained especially during stage (iii) and until the end of the reaction; the operations (iv) and (v) are thus usually performed at this value of between 85 and 98° C. and at constant temperature.

At the end of the stages which have just been described, a silica slurry is obtained which is then separated (liquid-solid separation).

This separation comprises a filtration, followed by washing if necessary, and a disintegration, said disintegration being preferably performed in the presence of at least one aluminum compound B.

The disintegration process, which may be carried out, for example, by passing the filter cake through a mill of the colloid or bead type, makes it possible in particular to lower the viscosity of the suspension to be subsequently dried.

The aluminum compound B is preferably an alkali metal, especially potassium, or very preferably sodium, aluminate. It is usually identical to the aluminum compound A mentioned above.

Advantageously, said disintegration is performed in the presence of at least one acidifying agent as described above.

When the aluminum compound B is present at the disintegration stage, this acidifying agent may be subsequently or preferably simultaneously added to the aluminum compound B.

The quantities of the aluminum compounds A and if appropriate B employed in the process of preparation according to the invention are preferably such that the precipitated silica thus prepared contains at least 0.35%, in particular at least 0.45%, for example between 0.50 and 1.50%, or even between 0.75 and 1.40%, by weight of aluminum.

The separation used in the process of preparation according to the invention usually includes a filtration performed by means of any suitable method, for example by means of a belt filter, a rotary vacuum filter or, preferably, a filter press.

The suspension of precipitated silica thus recovered (filter cake) is then dried.

According to one characteristic of the process of preparation according to the invention, this suspension must exhibit, immediately before its drying, a solids content of not more than 24% by weight, preferably not more than 22% by weight.

This drying may be done according to any method that is known per se.

The drying is preferably done by spraying.

Any suitable type of sprayer may be employed for this purpose, especially a turbine, nozzle, liquid-pressure or two-fluid sprayer.

According to one embodiment of the invention, the suspension to be dried has a solids content higher than 15% by weight, preferably higher than 17% by weight and, for example, higher than 20% by weight. The drying is then preferably performed by means of a nozzle sprayer.

The precipitated silica capable of being obtained according to this embodiment of the invention and preferably by using a filter press is advantageously in the form of substantially spherical beads, preferably of a mean size of at least 80 μm.

It should be noted that dry material for example silica in pulverulent form may be also added to the filter cake after the filtration, at a subsequent stage of the process.

At the end of the drying, a stage of milling may be undertaken on the product recovered, especially on the product obtained by drying a suspension which has a solids content higher than 15% by weight. The precipitated silica which is then obtainable is generally in the form of a powder, preferably with a mean size of at least 15 μm, in particular between 15 and 60 μm, for example between 20 and 45 μm.

The milled products with the desired particle size can be separated from any nonconforming products by means, for example, of vibrating sieves which have appropriate mesh sizes, and the nonconforming products thus recovered can be returned to the milling.

Similarly, according to another embodiment of the invention, the suspension to be dried has a solids content of at most 15% by weight. The drying is then generally performed by means of a turbine sprayer. The precipitated silica which is then obtainable according to this embodiment of the invention and preferably by using a rotary vacuum filter is generally in the form of a powder, preferably with a mean size of at least 15 μm, in particular between 30 and 150 μm, for example between 45 and 120 μm.

Finally, the product which has been dried (especially from a suspension which has a solids content of at most 15% by weight) or milled can, according to another embodiment of the invention, be subjected to an agglomeration stage.

Agglomeration is here intended to mean any process which enables finely divided objects to be bonded together in order to bring them into the form of objects of larger size and which are mechanically stronger.

These processes are especially direct compression, wet-route granulation (that is to say with the use of a binder such as water, silica slurry, etc.), extrusion and, preferably, dry compacting.

When this last technique is used it may be found advantageous, before starting the compacting, to deaerate the pulverulent products (an operation which is also called predensifying or degassing), so as to remove the air included therein and to ensure a more uniform compacting.

The precipitated silica which can be obtained according to this embodiment of the invention is advantageously in the form of granules, preferably at least 1 mm in size, in particular between 1 and 10 mm.

At the end of the agglomeration stage the products may be classified to a desired size, for example by sieving, and then packaged for their future use.

The powders, as well as the beads, of precipitated silica which are obtained by the process according to the invention thus offer the advantage, among others, of providing access to granules such as those mentioned above, in a simple, efficient and economical manner, especially by conventional forming operations, such as, for example, granulation or compacting, without the latter resulting in degradation capable of masking, or even annihilating, the good intrinsic properties associated with these powders or these beads, as may be the case in the prior art when using conventional powders.

The precipitated silicas obtained according to the process of the present invention have a very good dispersibility (and disintegratability) and very satisfactory reinforcing properties, in particular which, when employed as a reinforcing filler for elastomers, impart good rheological properties to the latter while providing very satisfactory mechanical properties.

Thus, the precipitated silicas obtained according to the process of the present invention generally possess the following characteristics:

a BET specific surface of between 120 and 300 m²/g, preferably between 130 and 270 m²/g, in particular between 140 and 200 m²/g,

a DOP oil uptake lower than 300 ml/100 g, preferably between 200 and 295 ml/100 g,

a median diameter (Ø₅₀), after disintegration with ultrasound, smaller than 3 μm,

an ultrasonic disintegration factor (F_{D}) higher than 5.5 ml, in particular higher than 11 ml, for example higher than 12.5 ml,

a pore distribution such that the pore volume consisting of the pores whose diameter is between 175 and 275 Å represents less than 50% of the pore volume consisting of the pores of diameters smaller than or equal to 400 Å,

an aluminum content of at least 0.35% by weight, preferably at least 0.45% by weight.

They preferably have an aluminum content of between 0.50 and 1.50% by weight; this content may be especially between 0.75 and 1.40% by weight.

One of the characteristics of the silica obtained according to the invention usually lies in the distribution, or spread, of the pore volume and especially in the distribution of the pore volume which is produced by the pores of diameters smaller than or equal to 400 Å. This latter volume corresponds to the useful pore volume of the fillers which are employed in the reinforcement of elastomers. Analysis of the programs shows that this silica preferably then has a pore distribution such that the pore volume consisting of the pores whose diameter is between 175 and 275 Å represents less than 50%, for example less than 40%, of the pore volume consisting of the pores of diameters smaller than or equal to 400 Å.

The precipitated silicas thus obtained generally have a CTAB specific surface of between 100 and 240 m²/g, preferably between 130 and 225 m²/g, for example between 140 and 200 m²/g.

According to an alternative form of the invention, the silica obtained has a BET specific surface/CTAB specific surface ratio of between 1.0 and 1.2, that is to say that it preferably has a low microporosity.

The pH of the silica according to the invention is generally between 6 and 7.5, for example between 6.1 and 7.3.

The silicas prerpared according to the process of the invention may be in the form of powder, of substantially spherical beads or, optionally, of granules, and are characterized particularly by the fact that, while being relatively large in size, they have a very good dispersibility and disintegratability and very satisfactory reinforcing properties. They thus exhibit a dispersibility and disintegratability that are advantageously superior to that of the silicas of the prior art, which are identical or closely related in specific surface and identical or closely related in size.

The silica powders preferably have a mean size of at least 15 μm; the latter is, for example, between 15 and 60 μm (especially between 20 and 45 μm) or between 30 and 150 μm (especially between 45 and 120 μm).

The packing density (PD) of the said powders is generally at least 0.17 and, for example, between 0.2 and 0.3.

The said powders generally have a total pore volume of at least 2.5 cm³/g and, more particularly, of between 3 and 5 cm³/g.

They make it possible in particular to obtain a very good compromise between processing and mechanical properties in the vulcanized state.

They also constitute preferred precursors for the synthesis of granulates as described later.

The substantially spherical beads capable of being obtained according to the invention preferably have a mean size of at least 80 μm.

This mean bead size can be at least 100 μm, for example at least 150 μm; it is generally at most 300 μm and preferably lies between 100 and 270 μm. This mean size is determined according to NF standard X 11507 (December 1970) by dry sieving and determination of the diameter corresponding to a cumulative oversize of 50%.

They preferably have a DOP oil uptake of between 240 and 290 m/1100 g.

The packing density (PD) of the said beads (or pearls) is generally at least 0.17 and, for example, between 0.2 and 0.34.

They usually have a total pore volume of at least 2.5 cm³/g and, more particularly, of between 3 and 5 cm³/g.

As indicated above, such a silica in the form of substantially spherical beads which are advantageously filled (full, i.e. not hollow), homogeneous and low in dust and have good pourability, has an excellent disintegratability and dispersibility. In addition, it exhibits good reinforcing properties. Such a silica also constitutes a preferred precursor for the synthesis of powders and granules.

Such a silica in the form of substantially spherical beads constitutes a highly advantageous alternative form of the silicas prepared according to the process of the present invention.

The dimensions of the granules capable of being obtained according to the invention are preferably at least 1 mm, in particular between 1 and 10 mm, along the axis of their largest dimension (length).

They preferably have a DOP oil uptake of between 200 and 260 ml/100 g.

Said granules may be of the most diverse shape. The shapes which may be especially mentioned by way of example are spherical, cylindrical, parallelepipedal, tablet, flake, pellet and extrudate of circular or polylobar section.

The packing density (PD) of said granules is generally at least 0.27 and may range up to 0.37.

They generally have a total pore volume of at least 1 cm³/g and, more particularly, between 1.5 and 2 cm³/g.

The silicas prepared by the process according to the invention find a particularly advantageous application in the reinforcement of natural or synthetic elastomers. They impart excellent rheological properties to these elastomers while providing them with good mechanical properties and, in general, good resistance to abrasion. In addition, these elastomers are preferably less liable to reduced overheating.

The following examples illustrate the invention without, however, limiting its scope.

### EXAMPLE 1

4 830 g of water, 2 839 g of a concentrated sodium sulfate solution at 46.8 g/l and 4 370 g of sodium silicate having a WR=3.47 to 236 g/l as SiO₂ (WR means weight ratio of SiO₂ to Na₂O) are introduced into a reactor equipped with a system for regulating temperature and pH and a stirring system using propellers.

After starting the stirring (250 rpm) the base stock thus prepared is heated to 84° C. and the pH is brought to 8 over 50 minutes by adding an aqueous sulfuric acid solution at 80 g/l (mean flow rate of 91 g/minute). During this phase of gradual neutralization, after 35 minutes, the base stock is heated with a ramp temperature gradient of 1° C./min. When the temperature of 92° C. is reached, 1 080 g of sodium silicate (236 g/l) and 1 320 g of dilute sulfuric acid (80 g/l) are simultaneously added. The latter quantity of acid is adjusted so as to keep the pH of the medium at a constant value of 8. After 30 minutes of addition, the addition of silicate is stopped, and 64 grams of sodium aluminate (24%) are added over 5 minutes. The addition of acid is continued until the pH of the reaction mixture is stabilized at 5.2. The reaction slurry is filtered, the cake obtained is disintegrated with 0.3% of aluminum in the form of sodium aluminate (24% dry extract Al₂O₃; the solids content of the resulting slurry is 16%) and spray-dried.

### EXAMPLE 2

4 830 g of water, 2 839 g of a concentrated sodium sulfate solution at 46.8 g/l and 4 370 g of sodium silicate having a WR=3.47 to 236 g/l as SiO₂ are introduced into a reactor equipped with a system for regulating temperature and pH and a stirring system using propellers.

After starting the stirring (250 rpm) the base stock thus prepared is heated to 84° C. and the pH is brought to 8 over 50 minutes by adding an aqueous sulfuric acid solution at 80 g/l (mean flow rate of 91 g/minute). During this phase of gradual neutralization, after 35 minutes, the base stock is heated with a ramp temperature gradient of 1° C./min. When the temperature of 92° C. is reached, 1 080 g of sodium silicate (236 g/l) and 1 320 g of dilute sulfuric acid (80 g/l) are simultaneously added. The latter quantity of acid is adjusted so as to keep the pH of the medium at a constant value of 8. After 30 minutes of addition, the addition of silicate is stopped, and 64 grams of sodium aluminate (24%) are added over 5 minutes. The addition of acid is continued until the pH of the reaction mixture is stabilized at 5.2. The reaction slurry is filtered, the cake obtained is disintegrated without addition of aluminate (the solids content of the resulting slurry is 16%) and spray-dried.

### EXAMPLE 3

4 830 g of water, 2 839 g of a concentrated sodium sulfate solution at 46.8 g/l and 4 370 g of sodium silicate having a WR=3.47 to 236 g/l as SiO₂ are introduced into a reactor equipped with a system for regulating temperature and pH and a stirring system using propellers.

After starting the stirring (250 rpm) the base stock thus prepared is heated to 84° C. and the pH is brought to 8 over 50 minutes by adding an aqueous sulfuric acid solution at 80 g/l (mean flow rate of 91 g/minute). During this phase of gradual neutralization, after 35 minutes, the base stock is heated with a ramp temperature gradient of 1° C./min. When the temperature of 92° C. is reached, 1 080 g of sodium silicate (236 g/l) and 1 320 g of dilute sulfuric acid (80 g/l) are simultaneously added. The latter quantity of acid is adjusted so as to keep the pH of the medium at a constant value of 8. After 30 minutes of addition, the addition of silicate is stopped, and 32 grams of sodium aluminate (24%) are added over 5 minutes. The addition of acid is continued until the pH of the reaction mixture is stabilized at 5.2. The reaction slurry is filtered, the cake obtained is disintegrated with 0.3% of aluminum (the solids content of the resulting slurry is 16%) and spray-dried.

The physico-chemical properties of the silicas obtained according to examples 1 to 3 are given in table 1 below.

TABLE 1

| Ex. No. | pH | SO4 | Hum. | PAF | BET | CTAB | F_{D} | ø₅₀ | R Si |
|---|---|---|---|---|---|---|---|---|---|
| 1 | 6.2 | 1.5 | 6.4 | 10.7 | 152 | 150 | 12.6 | 1.6 | 0.67 |
| 2 | 6.8 | 1.7 | 8.4 | 11.9 | 154 | 153 | 13.2 | 1.8 | 0.53 |
| 3 | 6.5 | 1.4 | 6.8 | 11.5 | 162 | 162 | 16 | 1.7 | 0.55 |

SO4 represents the percentage by mass of Na₂SO₄ salt present in the solid, Hum. represents the percentage by mass of water present in the solid desorbing at 105° C. for 2 hours, PAF represents the percentage of mass lost during calcining at 1 000° C. for 2 hours.

The silane reactivity (R Si) is measured according to the following procedure:

10.62 g of Si69 (bis[3-triethyoxysilylpropyl) tetrasulfane]), 12.040 g of silica and 60.2 g of xylene are introduced into a 250 ml round-bottomed flask. The round-bottomed flask, equipped with a condenser, is placed in an oil bath at 120° C., with magnetic stirring. The grafting reaction lasts for 2 hours. The non-graft silane Si69 is then assayed by infrared by monitoring the peak at 960 cm⁻¹, a calibration curve having been established beforehand.

Thus, R Si is representative of the reactivity of the silica produced toward a coupling agent.

The silicas prepared according to the process of the present invention have a good productivity-reactivity compromise.

1. A process for the preparation of precipitated silica of the type including the reaction of a silicate with an acidifying agent, whereby a suspension of precipitated silica is obtained, followed by the separation and the drying of this suspension, in which the precipitation is carried out in the following manner:
(i) an initial base stock comprising a silicate and an electrolyte is formed, the silicate concentration (expressed as SiO₂) in said initial base stock being lower than 100 g/l and the electrolyte concentration in said initial base stock being lower than 17 g/l,
(ii) the acidifying agent is added to said base stock until a pH value of the reaction mixture of at least approximately 7 is obtained,
(iii) the acidifying agent and a silicate are added simultaneously to the reaction mixture, and in which a suspension which has a solids content of not more than 24% by weight is dried,
characterized in that said process includes the following operation:
(iv) at least one aluminum compound A is added to the reaction mixture after stage (iii), and then (v) an acidifying agent is added to the reaction mixture, said separation comprising a filtration and a disintegration of the cake originating from this filtration, said disintegration being preferably performed in the presence of at least one aluminum compound B.

2. The process as claimed in claim 1, characterized in that during stages (iv) and (v) and between these two stages, no basic agent and silicate is added.

3. The process as claimed in one of the preceding claims, characterized in that after the simultaneous addition of stage (iii), the addition of silicate is stopped, but the addition of an acidifying agent continues during stage (iv) such that the pH value is constantly equal (to within ±0.1) to that reached at the end of stage (ii).

4. The process as claimed in one of the preceding claims, characterized in that an acidifying agent is added to the reaction mixture according to stage (v) preferably such that a pH value of the reaction mixture of between 3 and 6.5, in particular 4 and 6, is obtained.

5. The process as claimed in any one of the preceding claims, characterized in that the silicate is an alkali metal silicate.

6. The process as claimed in any one of the preceding claims, characterized in that the acidifying agent used is chosen from sulfuric acid, nitric acid or hydrochloric acid, acetic acid, formic acid and carbonic acid.

7. The process as claimed in any one of the preceding claims, characterized in that the acidifying agent used during stage (v) is identical to that used during stages (ii) and (iii).

8. The process as claimed in any one of the preceding claims, characterized in that the simultaneous addition relating to stage (iii) is carried out so that the pH value is constantly equal (to within ±0.1) to that reached at the end of stage (ii).

9. The process as claimed in any one of the preceding claims, characterized in that the aluminum compound A and optionally the aluminum compound B is an alkali metal, especially potassium, or very preferably sodium, aluminate.

10. The process as claimed in any one of the preceding claims, characterized in that the quantities of the aluminum compounds A and if appropriate B are such that the precipitated silica prepared contains at least 0.35%, in particular at least 0.45%, for example between 0.50 and 1.50%, or even between 0.75 and 1.40%, by weight of aluminum.

11. The use, as reinforcing filler for elastomers, of a silica obtained by the process as claimed in any one of the preceding claims.
